(19) United States
(12) Patent Application Publication
(10) Pub. No.: US 2026/0355775 A1
(43) Pub. Date: Nov. 12, 2026

(54) MAGNETIC ATTRACTION SLIDING SLEEVE AND SLIDING SLEEVE ASSEMBLY

(71) Applicant: Xiamen Galenpoo Kitchen&Bathroom Technology Co.,Ltd., Xiamen (CN)

(72) Inventor: Xiaoling YAN, Xiamen (CN)

(73) Assignee: Xiamen Galenpoo Kitchen&Bathroom Technology Co.,Ltd., Xiamen (CN)

(21) Appl. No.: 19/336,437

(22) Filed: Sep. 22, 2025

(30) Foreign Application Priority Data
May 12, 2025 (CN) 202520925994.1

(51) Int. Cl. B05B 15/62; B05B 1/18; B05B 15/68; E03C 1/06

(52) U.S. Cl. CPC B05B 15/62; B05B 1/18; B05B 15/68; E03C 1/06; E03C 1/066

(57) ABSTRACT

The present invention discloses a magnetic attraction sliding sleeve and a sliding sleeve assembly. The magnetic attraction sliding sleeve comprises a sliding sleeve seat and a rotating seat. The sliding sleeve seat has a first end and a second end. The rotating seat is rotationally connected to the first end and is assembled with a magnetic attraction structure. The second end is provided with a handwheel structure. The sliding sleeve seat internally includes a clamping mechanism that cooperates with the handwheel structure to clamp or release a shower rod. Compared with the prior art, the magnetic attraction sliding sleeve of the present invention is easy to mount, use, and operate, aligning with user habits. The showerhead retrieval operation is smooth and free of stuttering, significantly improving ease of use and practicality.

### RELATED APPLICATIONS

The present patent document claims the benefit of priority to Patent Application No. 202520925994.1, filed May 12, 2025, and entitled “MAGNETIC ATTRACTION SLIDING SLEEVE AND SLIDING SLEEVE ASSEMBLY,” the entire contents of each of which are incorporated herein by reference.

### BACKGROUND

### 1. Technical Field

The present invention relates to the technical field of bathroom accessories, specifically to a magnetic attraction sliding sleeve and a sliding sleeve assembly.

### 2. Background Information

A sliding sleeve is a device sleeving a shower rod to support and position a showerhead, for example, Chinese patent No. ZL202110897858.2 having disclosed an easy-to-operate sliding seat. The sliding sleeve, after sleeving the shower rod, can slide up and down on the shower rod, with a clamping mechanism provided in the sliding sleeve to tightly hold the shower rod, so as to fix the sliding sleeve. The back surface of the showerhead is provided with a hooking structure, and the hooking structure is driven to move by operating a button, thus connecting the showerhead to the sliding sleeve or removing it therefrom.

In the prior art, the sliding sleeve must sleeve onto or be removed from an end of the shower rod, resulting in issues of inconvenient mounting and replacement. Moreover, the sliding sleeve is provided with the hooking structure for positioning the showerhead, which is a complex design. Removal is achieved by first operating the button, and any delay in the operation is likely to cause a stuttering sensation, failing to cater to user habits.

Given this situation, to further improve the ease of use and practicality of the sliding sleeve, this applicant has conducted in-depth research and proposed the present invention.

### BRIEF SUMMARY

An objective of the present invention is to provide a magnetic attraction sliding sleeve and a sliding sleeve assembly, which are convenient and easy to mount, use, and operate, catering to user habits, significantly improving the ease of use and practicality of the sliding sleeve.

To achieve the above objective, the solution of the present invention is:

The magnetic attraction sliding sleeve includes a sliding sleeve seat and a rotating seat, where the sliding sleeve seat is provided with a first end and a second end located on two sides, the rotating seat is rotationally connected to the first end of the sliding sleeve seat, the rotating seat is assembled with a magnetic attraction structure, the second end of the sliding sleeve seat is provided with a handwheel structure, and the sliding sleeve seat is internally provided with a clamping mechanism that is in linkage cooperation with the handwheel structure to clamp or release a shower rod.

Further, the sliding sleeve seat is further provided with an opening groove for sleeving a shower rod, the first end and the second end of the sliding sleeve seat are respectively located on two sides of the opening groove, the clamping mechanism includes a first inner core body and a second inner core body, the first inner core body is provided with a first half clamp sleeve and a connector respectively located on two sides of the opening groove, and an inner core slot formed between the first half clamp sleeve and the connector and corresponding to the opening groove, the connector is connected with a screw rod extending out of the second end of the sliding sleeve seat, the handwheel structure is provided with a threaded slot engaging with the screw rod, the second inner core body sleeves the connector, an outer end of the second inner core body abuts against the handwheel structure, and an inner end of the second inner core body is provided with a second half clamp sleeve that engages with the first half clamp sleeve.

Further, the first half clamp sleeve is provided with a first inner clamp portion, a first outer clamp portion, and an abutting and limiting portion detachably mounted between the first inner clamp portion and the first outer clamp portion, and the second half clamp sleeve is provided with a second outer clamp portion and a second inner clamp portion that are arranged in an inner-outer forked manner.

Further, a first guide structure is provided between the first inner core body and the sliding sleeve seat, and a second guide structure is provided between the first inner core body and the second inner core body, the first guide structure and the second guide structure are a slide groove and a slide rail engaging with the slide groove, respectively.

Further, a rotational connection structure is provided between the rotating seat and the sliding sleeve seat, the rotational connection structure includes a friction ring, a friction bushing, and a screw piece, an end portion of the first end of the sliding sleeve seat is provided with a connection hole, the friction bushing is sleeved between the rotating seat and the connection hole and is locked by the screw piece, the friction ring is embedded in the rotating seat, and the end portion of the first end of the sliding sleeve seat is clamped between the friction ring and the friction bushing.

Further, the magnetic attraction structure includes a first magnetic piece formed on the rotating seat and an annular body protruding around a periphery of the first magnetic piece, and a periphery of an end portion of the annular body is provided with a clamp ring.

The sliding sleeve assembly includes the magnetic attraction sliding sleeve and a showerhead, where the magnetic attraction structure includes the first magnetic piece formed on the rotating seat and the annular body protruding around the periphery of the first magnetic piece, and the periphery of the end portion of the annular body is provided with the clamp ring;
a back surface of the showerhead is provided with an annular groove engaging with the annular body during magnetic attraction and a second magnetic piece located at a center of the annular groove and correspondingly cooperating with the first magnetic piece;
the annular groove is assembled with a locking seat that is radially movably displaceable, the locking seat has an inner blocking arm and an outer locking arm corresponding to inner and outer groove walls of the annular groove, a locking groove for accommodating the clamp ring is formed between the inner blocking arm and the outer locking arm, with the clamp ring axially limited by the outer locking arm, and the locking groove has a deformation opening for the clamp ring to abut against, deform, and embed into; and
an inner diameter value of a projection of the deformation opening in an axial direction is less than a radial width of the clamp ring, and the radial width of the clamp ring is less than a groove width of the annular groove.

Further, an end portion of the outer locking arm is provided with a clamp head for axially limiting the clamp ring, the clamp head is axially higher than an end portion of the inner blocking arm, the clamp head and the end portion of the inner blocking arm form the deformation opening, and the deformation opening is of a beveled structure that is low on an inner side and high on an outer side.

Further, the locking seat has a first position to displace inward axially and a second position to displace outward axially, at the first position, the inner blocking arm moves out of the annular groove and the clamp head extends at least partially into the annular groove, and at the second position, the clamp head moves out of the annular groove and the inner blocking arm extends at least partially into the annular groove.

Further, the deformation opening has a guide inclined surface formed at the end portion of the inner blocking arm, and with a plane perpendicular to the guide inclined surface taken as a projection surface, a distance between projections of the clamp head and the guide inclined surface on the projection surface is greater than the radial width of the clamp ring.

Further, a surface of the clamp head away from the locking groove forms an outer inclined surface, and a surface of the clamp head facing the locking groove forms an inner inclined surface.

After the use of the above solution, in the present invention, during mounting of the magnetic attraction sliding sleeve, the handwheel structure is first operated to release the clamping mechanism, so as to sleeve the shower rod, and then the handwheel structure is operated to enable the clamping mechanism to clamp the shower rod, thereby finishing mounting and fixing the magnetic attraction sliding sleeve on the shower rod. This is simple, convenient, and friendly for mounting, showing prominent ease of use.

When the height of the sliding sleeve is adjusted, the handwheel structure only needs to be operated to slightly release the clamping mechanism from the shower rod, allowing the sliding sleeve to be freely adjusted up and down along the shower rod. After adjustment to the corresponding position, the handwheel structure is operated to restore the clamping mechanism to the clamping state with the shower rod.

When the sliding sleeve supports and positions the showerhead for use, the rotating seat enables flexible adjustment of the water outlet angle of the showerhead, and the magnetic attraction structure ensures stable positioning of the showerhead on the rotating seat. It is convenient to remove the showerhead from the sliding sleeve or position the showerhead on the sliding sleeve.

As compared with the prior art, the magnetic attraction sliding sleeve of the present invention is easy to mount, use, and operate, catering to user habits; and the showerhead retrieval operation is smooth and free of stuttering, significantly improving the ease of use and practicality of the sliding sleeve.

### BRIEF DESCRIPTION OF THE DRAWINGS

FIG. 1 is a first schematic structural diagram of a magnetic attraction sliding sleeve according to the present invention.

FIG. 2 is a second schematic structural diagram of the magnetic attraction sliding sleeve according to the present invention.

FIG. 3 is a first exploded structural diagram of the magnetic attraction sliding sleeve according to the present invention.

FIG. 4 is a second exploded structural diagram of the magnetic attraction sliding sleeve according to the present invention.

FIG. 5 is a cross-sectional view of the magnetic attraction sliding sleeve according to the present invention.

FIG. 6 is a schematic structural diagram of a showerhead according to the present invention.

FIG. 7 is a schematic structural diagram of a magnetic attraction portion on the showerhead according to the present invention.

FIG. 8 is a first exploded structural diagram of FIG. 7.

FIG. 9 is a second exploded structural diagram of FIG. 7.

FIG. 10 is a schematic diagram of a first position of a locking seat.

FIG. 11 is a partial schematic structural diagram of FIG. 10.

FIG. 12 is a partial schematic structural diagram of a rotating seat.

FIG. 13 is a schematic diagram of a second position of the locking seat.

FIG. 14 is a schematic diagram of an internal structure of magnetic attraction according to the present invention.

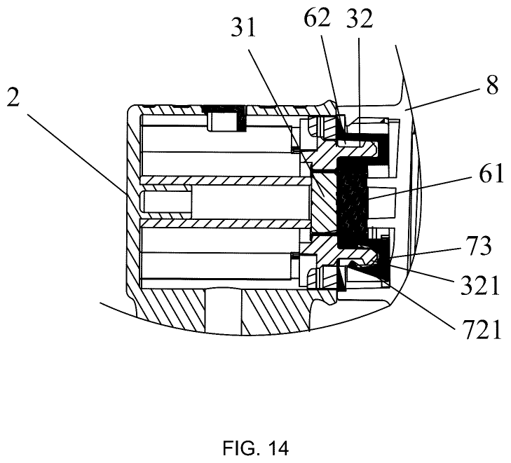

### REFERENCE NUMERAL DESCRIPTION

sliding sleeve seat 1, opening groove 10, first end 11, connection hole 111, second end 12, first slide groove 13;
rotating seat 2, friction ring 21, friction bushing 22, screw piece 23;
magnetic attraction structure 3, first magnetic seat 30, mounting hole 301, first magnetic piece 31, annular body 32, clamp ring 321, sheath 33;
handwheel structure 4, threaded slot 41, handle portion 42;
clamping mechanism 5, first inner core body 51, inner core slot 510, first half clamp sleeve 511, first inner clamp portion 5111, first outer clamp portion 5112, abutting and limiting portion 5113, connector 512, screw rod 513, first slide rail 514, second slide groove 515; second inner core body 52, second half clamp sleeve 521, second outer clamp portion 5211, second inner clamp portion 5212, second slide rail 522;
second magnetic seat 6, second magnetic piece 61, annular groove 62, mounting hole 621, groove notch 622, guide rail groove 623, sheath 63;
locking seat 7, guide rail 70, inner blocking arm 71, guide inclined surface 711, outer locking arm 72, clamp head 721, outer inclined surface 7211, inner inclined surface 7212, locking groove 73, deformation opening 731;
showerhead 8, mounting groove 81; and shower rod 9.

### DETAILED DESCRIPTION OF THE DRAWINGS AND THE PRESENTLY PREFERRED EMBODIMENTS

The present invention is further described in detail below with reference to the drawings and specific implementations.

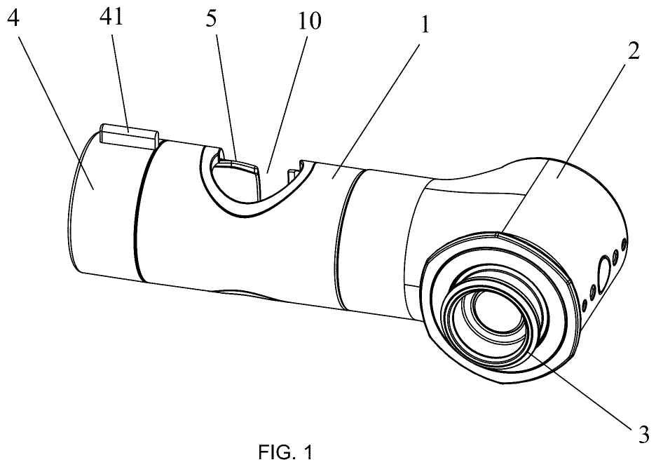

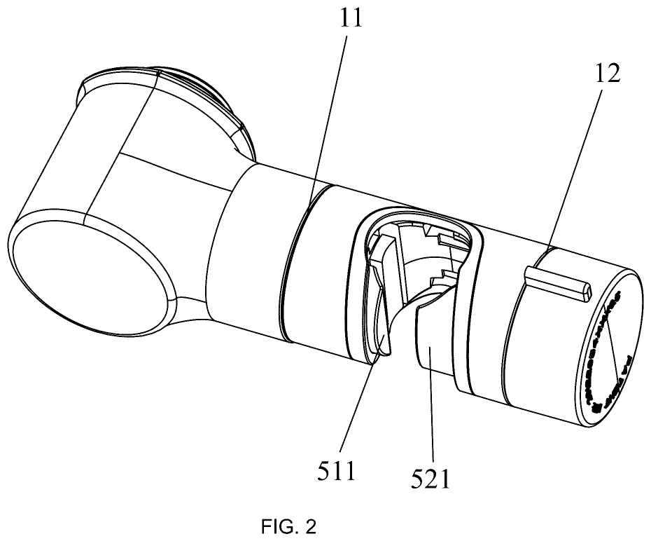

This case relates to a magnetic attraction sliding sleeve, as shown in FIGS. 1 to 5, including a sliding sleeve seat 1 and a rotating seat 2, the sliding sleeve seat 1 is provided with a first end 11 and a second end 12 located on two sides. The rotating seat 2 is rotationally connected to the first end 11 of the sliding sleeve seat 1, and the rotating seat 2 is assembled with a magnetic attraction structure 3. The second end 12 of the sliding sleeve seat 1 is provided with a handwheel structure 4, and the sliding sleeve seat 1 is internally provided with a clamping mechanism 5.

The sliding sleeve seat 1 is further provided with an opening groove 10 for sleeving a shower rod, and the first end 11 and the second end 12 of the sliding sleeve seat 1 are respectively located on two sides of the opening groove 10. The clamping mechanism 5 is in linkage cooperation with the handwheel structure 4 to clamp and fix or release and slide the shower rod 9 sleeved in the opening groove 10.

During mounting of the magnetic attraction sliding sleeve, the handwheel structure 4 is first operated to release the clamping mechanism 5, the opening groove 10 is directly aligned with the rod body of the shower rod to sleeve thereon, and then the handwheel structure 4 is operated to enable the clamping mechanism 5 to clamp the shower rod 9, thereby finishing mounting and fixing the magnetic attraction sliding sleeve on the shower rod 9. This is simple, convenient, and friendly for mounting, showing prominent ease of use.

When the height of the sliding sleeve is adjusted, the handwheel structure 4 only needs to be operated to slightly release the clamping mechanism 5 from the shower rod 9, allowing the sliding sleeve to be freely adjusted up and down along the shower rod 9. After adjustment to the corresponding position, the handwheel structure 4 is operated to restore the clamping mechanism 5 to the clamping state with the shower rod 9.

When the sliding sleeve supports and positions the showerhead for use, the rotating seat 2 enables flexible adjustment of the water outlet angle of the showerhead, and the magnetic attraction structure 3 ensures stable positioning of the showerhead on the rotating seat 2. It is convenient to remove the showerhead from the sliding sleeve or position the showerhead on the sliding sleeve.

As compared with the prior art, the magnetic attraction sliding sleeve of the present invention is easy to mount, use, and operate, catering to user habits; and the showerhead retrieval operation is smooth and free of stuttering, significantly improving the ease of use and practicality of the sliding sleeve.

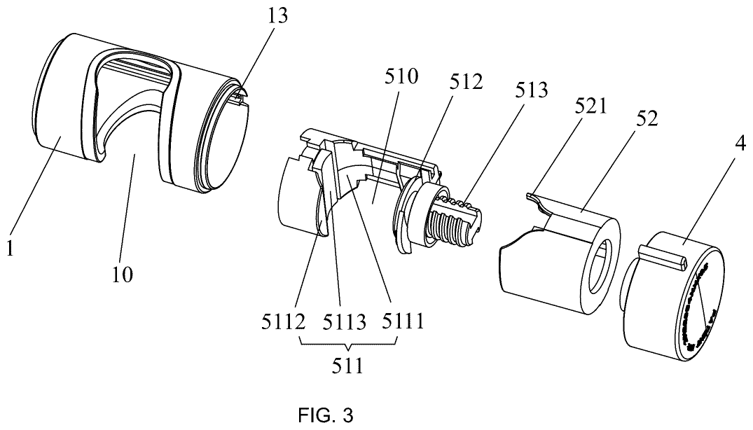

As shown in FIGS. 3 to 5, the clamping mechanism 5 includes a first inner core body 51 and a second inner core body 52, the first inner core body 51 is provided with a first half clamp sleeve 511 and a connector 512 respectively located on two sides of the opening groove 10, and an inner core slot 510 formed between the first half clamp sleeve 511 and the connector 512 and corresponding to the opening groove 10. The connector 512 is connected with a screw rod 513 extending out of the second end 12 of the sliding sleeve seat 1, and the handwheel structure 4 is provided with a threaded slot 41 engaging with the screw rod 513. The second inner core body 52 sleeves the connector 512, an outer end of the second inner core body 52 abuts against the handwheel structure 4, and an inner end of the second inner core body 52 is provided with a second half clamp sleeve 521 that engages with the first half clamp sleeve 511.

When the clamping mechanism 5 operates, the handwheel structure 4 is in linkage cooperation with the screw rod 513 via the threaded slot 41, driving the first half clamp sleeve 511 and the second half clamp sleeve 521 to approach each other to form a first working state, that is, tightly hold and lock the shower rod 9, or to leave each other to form a second working state, that is, release the shower rod 9. The handwheel structure 4 is provided with a handle portion 42 that facilitates rotational operation of the handwheel structure.

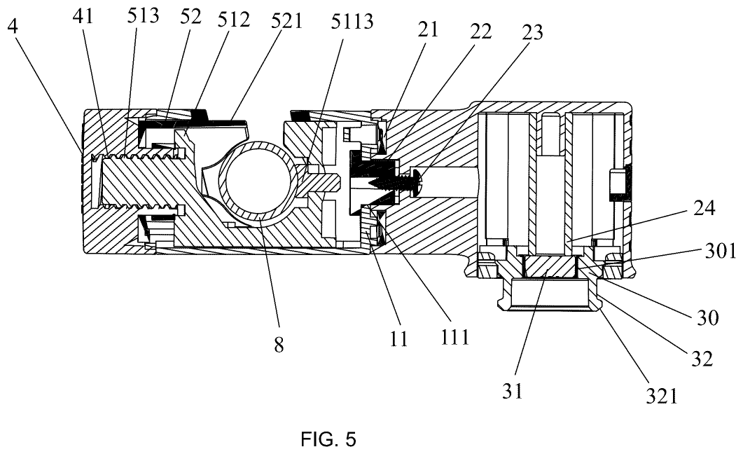

As shown in FIG. 5, during mounting of the sliding sleeve, the threaded slot 41 of the handwheel structure 4 is rotated leftward to disengage from the screw rod 513 or the two are separated from each other. In this case, the second inner core body 51 moves leftward, the second half clamp sleeve 521 exits the opening groove 10 leftward, the opening groove 10 is directly aligned with the rod body of the shower rod 9 to directly perpendicularly sleeve thereon, and the shower rod 9 is movably embedded into the inner core slot 510. Then, the handwheel structure 4 is rotated forward to gradually thread the threaded slot 41 with the screw rod 513, the handwheel structure 4 and the first inner core body 51 approach each other, the second inner core body 51, under the pushing of the handwheel structure 4, and the first inner core body 51 also approach each other, thereby driving the first half clamp sleeve 511 and the second half clamp sleeve 521 to approach each other until they tightly hold and lock the shower rod 9.

As shown in FIG. 5, when the height of the sliding sleeve on the shower rod 9 is adjusted, the handwheel structure 4 is slightly rotated in reverse, and similarly, under the linkage of the threaded structure, the first half clamp sleeve 511 and the second half clamp sleeve 521 slightly release the shower rod 9, enabling the sliding sleeve to be adjusted up and down. After adjustment to the corresponding position, the handwheel structure 4 is rotated forward to tighten.

In this embodiment, to enhance the locking strength of the first half clamp sleeve 511 and the second half clamp sleeve 521 on the shower rod 9, the first half clamp sleeve 511 is provided with a first inner clamp portion 5111, a first outer clamp portion 5112, and an abutting and limiting portion 5113 detachably mounted between the first inner clamp portion 5111 and the first outer clamp portion 5112. The second half clamp sleeve 521 is provided with a second outer clamp portion 5211 and a second inner clamp portion 5212 that are arranged in an inner-outer forked manner. In this way, the first half clamp sleeve 511 and the second half clamp sleeve 521 form multiple locking points, and the multiple locking points tightly fit with the shower rod 9 from different directions, achieving a stable and reliable clamping and locking effect. The abutting and limiting portion 5113 is of a detachable design, whereby, in practical applications, replacing the abutting and limiting portion 5113 allows the magnetic attraction sliding sleeve to be adapted to shower rods 9 of different sizes, meeting practical application needs.

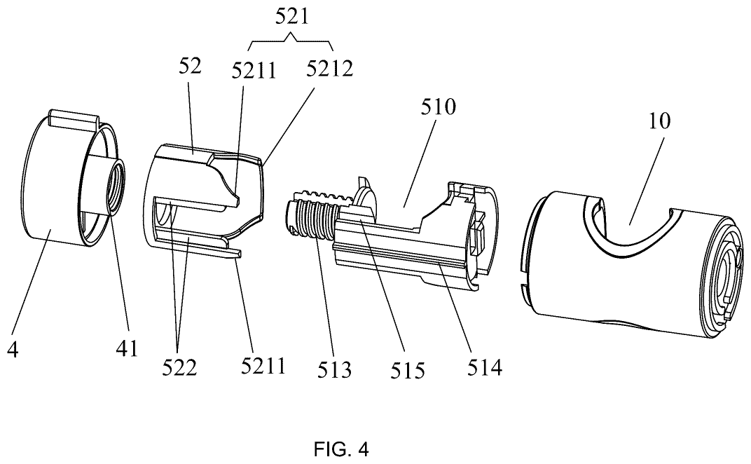

As shown in FIGS. 3 and 4, a first guide structure is provided between the first inner core body 51 and the sliding sleeve seat 1, and a second guide structure is provided between the first inner core body 51 and the second inner core body 52. In a specific implementation, the first guide structure and the second guide structure are a slide groove and a slide rail engaging with the slide groove, respectively. Specifically, a first slide groove 13 is formed in the sliding sleeve seat 1, a first slide rail 514 engaging with the first slide groove 13 is formed on the first inner core body 51, a second slide rail 522 is formed on the second inner core body 52, and a second slide groove 515 engaging with the second slide rail 522 is formed on the first inner core body 51. Thus, the first inner core body 51 and the second inner core body 52, under the guiding action of the first and second guide structures, can smoothly and precisely perform clamping or releasing displacement actions.

As shown in FIG. 5, a rotational connection structure is provided between the rotating seat 2 and the sliding sleeve seat 1, and the rotational connection structure includes a friction ring 21, a friction bushing 22, and a screw piece 23. An end portion of the first end 11 of the sliding sleeve seat 1 is provided with a connection hole 111, and the friction bushing 22 is sleeved between the rotating seat 2 and the connection hole 111 and is locked by the screw piece 23. The friction ring 21 is embedded in the rotating seat 2, and inner and outer surfaces of the end portion of the first end 11 of the sliding sleeve seat 1 are clamped between the friction bushing 22 and the friction ring 21. Thus, the rotating seat 2 is rotatably connected to the sliding sleeve seat 1 under the cooperative action of the friction bushing 22 and the screw piece 23, and under the tension of the screw piece 23, the friction bushing 22 and the friction ring 21 form a planar friction structure with the inner and outer surfaces of the end portion of the first end 11 from the inner and outer sides, respectively, enabling the rotating seat 2 to rotate arbitrarily and achieve real-time hovering positioning of the rotation angle. Further, a pin hole may be formed in the inner surface of the end portion of the first end 11 of the sliding sleeve seat 1, a positioning pin may be mounted in the pin hole, and a plurality of gear holes distributed circumferentially may be formed on the friction ring 21, whereby an audible indication is generated when the rotating seat 2 rotates to a set position.

In this embodiment, as shown in FIG. 5, the magnetic attraction structure 3 includes a first magnetic piece 31 formed on the rotating seat 2 and an annular body 32 protruding around a periphery of the first magnetic piece 31, and a periphery of an end portion of the annular body 32 is provided with a clamp ring 321. In a specific embodiment of structural mounting of the magnetic attraction structure 3, the magnetic attraction structure 3 has a first magnetic seat 30 locked on the rotating seat 2, a central portion of the first magnetic seat 30 is provided with a mounting hole 301 and the annular body 32 formed around a periphery of the mounting hole 301, a sheath 33 with an inward-facing opening is embedded in the mounting hole 301, and the first magnetic piece 31 is mounted in the sheath 33, and abutted against and positioned by an abutting portion 24 formed on the rotating seat 2. When the magnetic attraction structure 3 operates, the first magnetic piece 31 provides magnetic attraction force, and the annular body 32 and the clamp ring 321 thereon provide alignment, assembly, and limitation, achieving magnetic fixation of the showerhead on the magnetic attraction sliding sleeve.

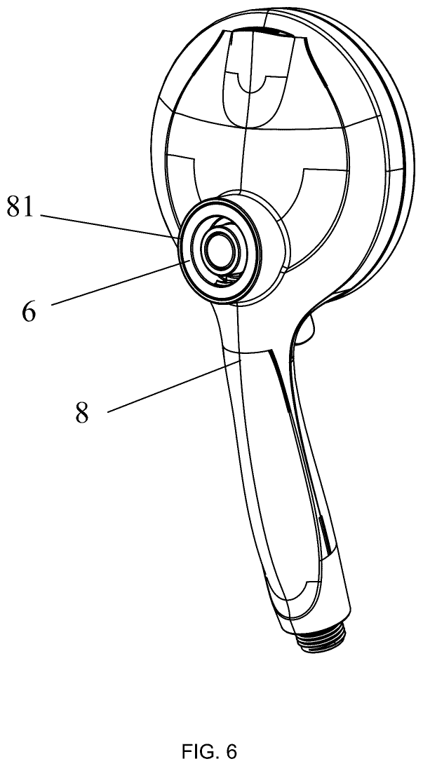

The present invention further relates to a sliding sleeve assembly, as shown in FIGS. 1 to 6, including a sliding sleeve and a showerhead 8, the sliding sleeve being the magnetic attraction sliding sleeve described above, where the magnetic attraction structure 3 includes the first magnetic piece 31 formed on the rotating seat 2 and the annular body 32 protruding around the periphery of the first magnetic piece 31, and the periphery of the end portion of the annular body 32 is provided with the clamp ring 321.

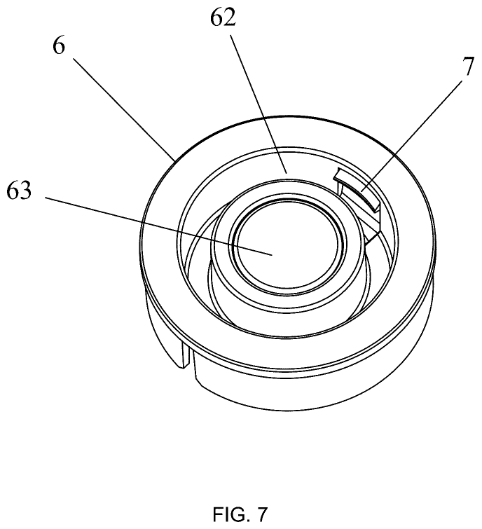

As shown in FIGS. 7 to 9, the back surface of the showerhead 8 is provided with an annular groove 62 engaging with the annular body 32 during magnetic attraction and a second magnetic piece 61 located at a center of the annular groove 62 and correspondingly cooperating with the first magnetic piece 31. In a specific structural embodiment, the back surface of the showerhead 8 is provided with a mounting groove 81 and a second magnetic seat 6 disposed in the mounting groove 81, the second magnetic seat 6 is provided with the annular groove 62, and the second magnetic piece 61 is correspondingly mounted at a center position of the annular groove 62. Specifically, a center of the annular groove 62 is provided with a mounting hole 621, a sheath 63 with an inward-facing opening is embedded in the mounting hole 621, and the second magnetic piece 61 is mounted in the sheath 63.

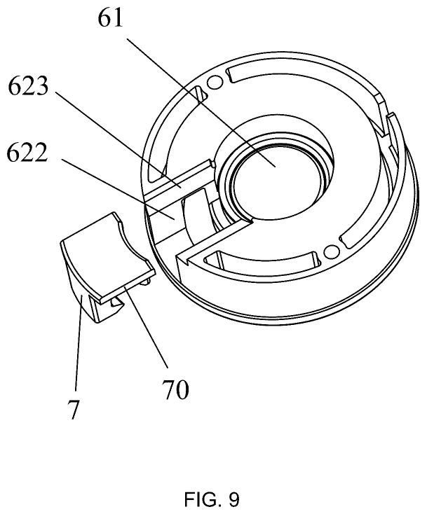

As shown in FIG. 9, the annular groove 62 is assembled with a locking seat 7 that is radially movably displaceable, and in a specific embodiment, the annular groove 62 is provided with a groove notch 622 and a guide rail groove 623 radially extending on the groove notch 622, and the locking seat 7 is provided with a guide rail 70 engaging with the guide rail groove 623. Through the guiding cooperation of the guide rail 70 and the guide rail groove 623, the locking seat 7 achieves radial displacement within the groove notch 622.

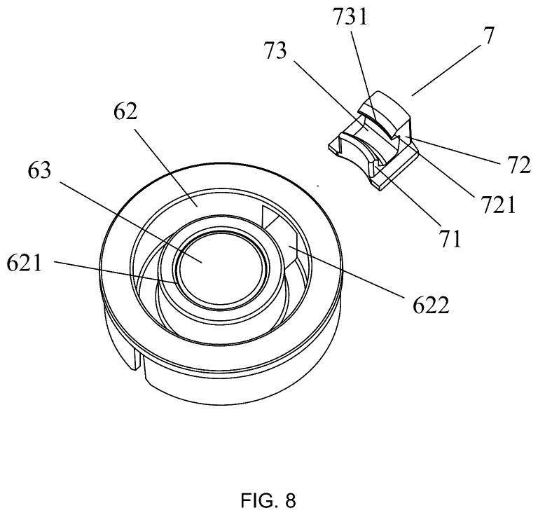

As shown in FIG. 8, the locking seat 7 has an inner blocking arm 71 and an outer locking arm 72 corresponding to inner and outer groove walls of the annular groove 62, a locking groove 73 for accommodating the clamp ring 321 is formed between the inner blocking arm 71 and the outer locking arm 72, with the clamp ring 321 axially limited by the outer locking arm 72, and the locking groove 73 has a deformation opening 731 for the clamp ring 321 to abut against, deform, and embed into.

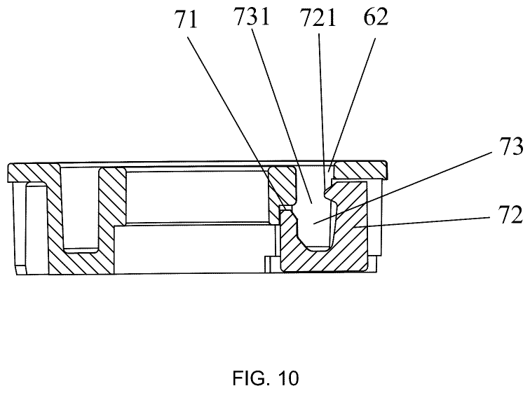

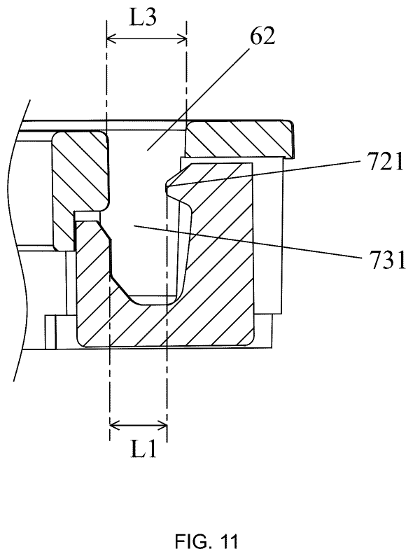

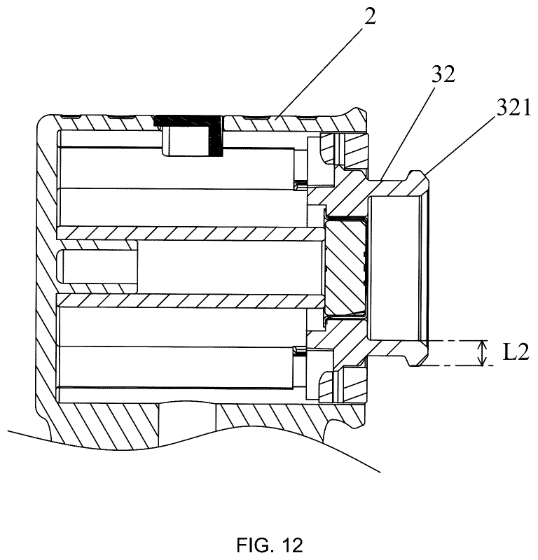

As shown in FIGS. 10 to 12, an inner diameter value L1 of a projection of the deformation opening 731 in an axial direction (up-down direction in FIG. 11) is less than a radial width L2 of the clamp ring 321, and the radial width L2 of the clamp ring 321 is less than a groove width L3 of the annular groove.

As shown in FIG. 11, when the showerhead 8 is magnetically positioned on the magnetic attraction sliding sleeve, the back surface of the showerhead 8 is brought close to the magnetic attraction structure 3 of the rotating seat 2. The first magnetic piece 31 and the second magnetic piece 61 mutually attract magnetically and guide center alignment, and the annular body 32 automatically aligns with and inserts into the annular groove 62. The clamp ring 321 on the annular body 32 approaches and abuts against the deformation opening 731 of the locking seat 7, causing slight expansion deformation of the deformation opening 731, and the clamp ring 321 adaptively embeds into the locking groove 73. Thereafter, the deformation opening 731 resets without force, the clamp ring 321 is confined within the locking groove 73, and with the outer locking arm 72 and the clamp ring 321 mutually interfering axially for limitation, the annular body 32 is firmly confined within the annular groove 62. Under the dual limitation of magnetic attraction and locking, the showerhead 8 is supported and positioned on the sliding sleeve with high reliability and stability, eliminating the possibility of the showerhead detaching.

The locking seat 7 adopts a radially movable displacement design on the annular groove 62, equivalent to forming a dynamic locking mechanism within the annular groove 62, creating a relationship with the clamp ring 321 that allows adaptive adjustment of relative positions. During the abutment process of the clamp ring 321, the dynamic locking mechanism can adaptively fine-tune the relative position between the two, enabling the clamp ring 321 to embed precisely and smoothly, and after embedding, it can adaptively adjust to mutual locking limitation, the overall dynamic process being highly natural, smooth, and free of stuttering.

When the showerhead 8 is removed from the sliding sleeve for use, the showerhead 8 is gripped with one hand, and force is applied in a direction roughly perpendicular to the contact surface between the showerhead and the rotating seat 2, driving the clamp ring 321 to abut against the deformation opening 731 from inside to outside. The deformation opening 731 adaptively shifts radially for fine-tuning and undergoes slight expansion deformation, the clamp ring 321 naturally disengages from the locking groove 73, and the annular groove 62 and the annular body 32 naturally separate, thus completing the removal of the showerhead 8 from the rotating seat 2. The operation requires only normal gripping force without additional cooperative actions, allowing for convenient and easy use, and providing a premium user experience.

Further, as shown in FIG. 10, an end portion of the outer locking arm 72 is provided with a clamp head 721 for axially limiting the clamp ring 321, the clamp head 721 is axially higher than an end portion of the inner blocking arm 71, the clamp head 721 and the end portion of the inner blocking arm 71 form the deformation opening 731, and the deformation opening 731 is of a beveled structure that is low on an inner side and high on an outer side. The inner blocking limitation point is at a lower position, and the outer locking point is at a higher position, such that when the clamp ring 321 and the deformation opening 731 abut against each other, they are already in a misaligned cooperative relationship appropriately extending toward the locking direction, at a critical point for deformation and embedding. The deformation opening 731 requires only minimal deformation to achieve embedding and locking, providing the user with an experience of seamlessly completing the locking and positioning.

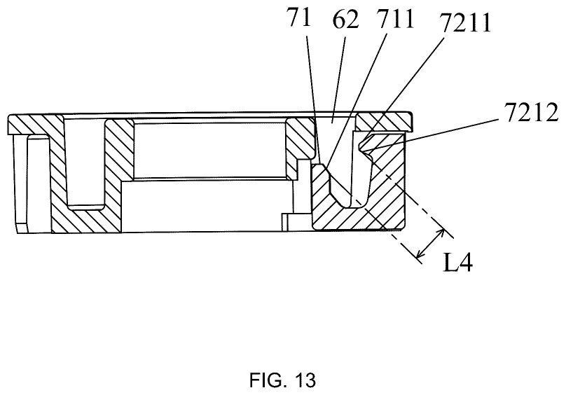

As shown in FIGS. 10 and 13, the locking seat 7 has a certain range of radial displacement to ensure the formation of the adaptive adjustment of the relative position relationship. The locking seat 7 has a first position to displace inward radially and a second position to displace outward radially. As shown in FIG. 10, at the first position, the locking seat 7 displaces inward radially, the inner blocking arm 71 moves out of the annular groove 62, that is, to a position outside the annular space defined by the inner and outer groove walls of the annular groove 62, and the clamp head 721 extends at least partially into the annular groove 62, that is, into the annular space defined by the inner and outer groove walls of the annular groove 62. As shown in FIG. 13, at the second position, the locking seat 7 displaces outward radially, the clamp head 721 moves out of the annular groove 62, and the inner blocking arm 71 extends at least partially into the annular groove 62. The locking seat 7 freely adjusts its displacement within the range defined by the first position and the second position, enabling adaptive dynamic alignment adjustment, thus achieving a clever and perfect locking and limiting function.

As shown in FIG. 13, the deformation opening 73 has a guide inclined surface 711 formed at the end portion of the inner blocking arm 71, and with a plane perpendicular to the guide inclined surface 711 taken as a projection surface, a distance L4 between projections of the clamp head 721 and the guide inclined surface 711 on the projection surface is greater than the radial width L2 of the clamp ring 321, such that an inner diameter of the deformation opening 73 in the inclined direction is greater than the radial width of the clamp ring 321. When the showerhead 8 is positioned on the magnetic attraction structure 3, as the clamp ring 321 abuts against the end portion of the inner blocking arm 71, the guide inclined surface 711 provides guidance, enabling easier deformation of the deformation opening 73. When the showerhead 8 is removed from the rotating seat 2, the applied force direction inevitably has a certain angular tilt (that is, an included angle exists between the force direction and the axial direction), and the inner diameter design of the deformation opening 73 in the inclined direction makes it easier for the clamp ring 321 to disengage from the deformation opening 73 under tilted external force, improving the ease and comfort of the user in the showerhead removal operation.

In this embodiment, as shown in FIG. 13, a surface of the clamp head 721 away from the locking groove 73 forms an outer inclined surface 7211, and a surface of the clamp head 721 facing the locking groove 73 forms an inner inclined surface 7212. The outer inclined surface 7211 and the inner inclined surface 7212 separately guide the clamp ring 321 during locking and releasing.

The above descriptions are merely preferred embodiments of the present invention, and all equivalent changes and modifications made within the scope of the claims of the present invention shall fall within the scope of the claims of the present invention.

1. A magnetic attraction sliding sleeve, comprising
a sliding sleeve seat having an opening groove configured to receive a shower rod from a lateral side of the shower rod, the sliding sleeve seat having a first end and a second end respectively located on opposite sides of the opening groove;
a clamping mechanism disposed in the sliding sleeve seat and configured to clamp or release the shower rod received in the opening groove;
a handwheel structure provided at the second end of the sliding sleeve seat and operatively linked with the clamping mechanism to actuate the clamping mechanism;
a rotating seat connected to the first end of the sliding sleeve seat by a rotational connection, the rotational connection being configured to provide a holding resistance between the rotating seat and the sliding sleeve seat such that the rotating seat is rotatable relative to the sliding sleeve seat and retainable at a selected angular position relative to the sliding sleeve seat while the clamping mechanism clamps the shower rod; and
a magnetic attraction structure mounted to the rotating seat and rotatable together with the rotating seat relative to the sliding sleeve seat, the magnetic attraction structure being configured to magnetically retain a showerhead on the rotating seat such that, when the showerhead is magnetically retained by the magnetic attraction structure, the showerhead is angularly adjustable together with the rotating seat relative to the sliding sleeve seat while remaining magnetically retained by the magnetic attraction structure.

2. The magnetic attraction sliding sleeve according to claim 1, wherein the sliding sleeve seat is further provided with an opening groove for sleeving a shower rod, the first end and the second end of the sliding sleeve seat are respectively located on two sides of the opening groove, the clamping mechanism comprises a first inner core body and a second inner core body, the first inner core body is provided with a first half clamp sleeve and a connector respectively located on two sides of the opening groove, and an inner core slot formed between the first half clamp sleeve and the connector and corresponding to the opening groove, the connector is connected with a screw rod extending out of the second end of the sliding sleeve seat, the handwheel structure is provided with a threaded slot engaging with the screw rod, the second inner core body sleeves the connector, an outer end of the second inner core body abuts against the handwheel structure, and an inner end of the second inner core body is provided with a second half clamp sleeve that engages with the first half clamp sleeve.

3. The magnetic attraction sliding sleeve according to claim 2, wherein the first half clamp sleeve is provided with a first inner clamp portion, a first outer clamp portion, and an abutting and limiting portion detachably mounted between the first inner clamp portion and the first outer clamp portion, and the second half clamp sleeve is provided with a second outer clamp portion and a second inner clamp portion that are arranged in an inner-outer forked manner.

4. The magnetic attraction sliding sleeve according to claim 1, wherein the rotational connection comprises a rotational connection structure, the rotational connection structure is provided between the rotating seat and the sliding sleeve seat, the rotational connection structure comprises a friction ring, a friction bushing, and a screw piece, an end portion of the first end of the sliding sleeve seat is provided with a connection hole, the friction bushing is sleeved between the rotating seat and the connection hole and is locked by the screw piece, the friction ring is embedded in the rotating seat, and the end portion of the first end of the sliding sleeve seat is clamped between the friction ring and the friction bushing.

5. The magnetic attraction sliding sleeve according to claim 1, wherein the magnetic attraction structure comprises a first magnetic piece formed on the rotating seat and an annular body protruding around a periphery of the first magnetic piece, and a periphery of an end portion of the annular body is provided with a clamp ring.

6. A sliding sleeve assembly, comprising a showerhead and the magnetic attraction sliding sleeve according to claim 1, wherein the magnetic attraction structure comprises a first magnetic piece formed on the rotating seat and an annular body protruding around the periphery of the first magnetic piece, and the periphery of the end portion of the annular body is provided with a clamp ring;
a back surface of the showerhead is provided with an annular groove engaging with the annular body during magnetic attraction and a second magnetic piece located at a center of the annular groove and correspondingly cooperating with the first magnetic piece;
the annular groove is assembled with a locking seat that is radially movably displaceable, the locking seat has an inner blocking arm and an outer locking arm corresponding to inner and outer groove walls of the annular groove, a locking groove for accommodating the clamp ring is formed between the inner blocking arm and the outer locking arm, with the clamp ring axially limited by the outer locking arm, and the locking groove has a deformation opening for the clamp ring to abut against, deform, and embed into; and
a width of the deformation opening as measured in a direction perpendicular to the axis of the deformation opening is less than a radial width of the clamp ring, and the radial width of the clamp ring is less than a groove width of the annular groove.

7. The sliding sleeve assembly according to claim 6, wherein an end portion of the outer locking arm is provided with a clamp head for axially limiting the clamp ring, the clamp head is axially higher than an end portion of the inner blocking arm, the clamp head and the end portion of the inner blocking arm form the deformation opening, and the deformation opening is of a beveled structure that is low on an inner side and high on an outer side.

8. The sliding sleeve assembly according to claim 7, wherein the locking seat has a first position to displace inward radially and a second position to displace outward radially, at the first position, the inner blocking arm moves out of the annular groove and the clamp head extends at least partially into the annular groove, and at the second position, the clamp head moves out of the annular groove and the inner blocking arm extends at least partially into the annular groove.

9. The sliding sleeve assembly according to claim 7, wherein the deformation opening has a guide inclined surface formed at the end portion of the inner blocking arm, and a distance between the clamp head and the guide inclined surface, as measured along a direction perpendicular to the guide inclined surface is greater than the radial width of the clamp ring.

10. The sliding sleeve assembly according to claim 7, wherein a surface of the clamp head away from the locking groove forms an outer inclined surface, and a surface of the clamp head facing the locking groove forms an inner inclined surface.
